(19) United States
(12) Patent Application Publication
(10) Pub. No.: US 2013/0115403 A1
(43) Pub. Date: May 9, 2013

(54) HIGHLY RESISTANT SELF-ADHESIVE LAMINATED COVER AND DEVICE TO FORM A SELF-ADHESIVE LAMINATED COVER

(71) Applicants: Carlos Alfredo Lima, Sao Paulo - SP (BR); Pedro Luis Tardeli, Santo-Andre-SP (BR); Edilson Dominicheli, Santo-Andre-SP (BR)

(72) Inventors: Carlos Alfredo Lima, Sao Paulo - SP (BR); Pedro Luis Tardeli, Santo-Andre-SP (BR); Edilson Dominicheli, Santo-Andre-SP (BR)

(73) Assignee: Pertech do Brasil LTDA, Sao Bernardo do Campo - SP (BR)

(21) Appl. No.: 13/809,331

(22) PCT Filed: Jul. 15, 2010
(86) PCT No.: PCT/BR2010/000238

§ 371 Date: Jan. 9, 2013

(51) Int. Cl. E04F 13/08; B32B 41/00

(52) U.S. Cl. CPC E04F 13/0871; B32B 41/00
USPC 428/40.2; 156/361; 428/40.1; 428/42.1

(57) ABSTRACT

A highly resistant self-adhesive laminated cover is disclosed, formed by a layered material comprising a cover plate (2), an intermediary layer of gluing material (3) and a protection film (4), wherein said cover plate (2) is intended to compose the external and apparent face of the laminated cover (1), while the protection film (4) is intended to be taken off before the application of the laminated cover (1), so to allow the contact between the receiving surface for the laminated cover (1) and the gluing material layer (3). A device (10) able to form said laminated cover (1) from an MDF or MDP plate and a double-face type adhesive is also disclosed.

### FIELD OF THE INVENTION

The present invention refers to a highly resistant self-adhesive laminated cover of the type as used to cover furniture, both internally and externally, and alternatively to cover floors, walls, division walls and similar. The present invention also refers to a device to form a highly resistant auto-adhesive cover from a conventional laminate.

### STATE OF THE ART

Covers intended to act as finishing for civil architecture and furniture fields, e. g. to cover internal and external faces of furniture, as well as to cover floors, walls, division walls and similar, are known in the art. Said covers are constituted by wooden-based plates, usually from cuttings, sawdust, chips, paper or any other wood “residues” or other parts of plants, to which at least an agglutinant component is added, intended to unify and make one single rigid body. Said plate covers may be laminated, aggregated and/or agglomerated, and have an external surface provided with an ornamental pattern, e. g. a pattern imitating a given noble wood, uniform colors, different ornamental pattern and others. Among these covers, the most well known ones include MDF and MDP aggregated materials. Furthermore, masonry, tile, dry-wall, mortar and mortar plate covers are also known, among others.

Still according to the state of the art, the application of said covers is made by the following steps: a. clean the area to receive the cover; b. apply a contact glue over said surface, taking care to have it uniformly dispersed over the area of application; wait a given time for the glue to be activated by reaction with the oxygen from environmental air; and put the cover plate over the area of application, by means of gluing and external pressure to guarantee good settling of the covering plate and eliminating intermediary bubbles. After the contact glue finally dries, finishing steps can be performed to adjust the edges of the cover to the edges of the application surface.

Despite this procedure being used for a long time, it is not free from inconveniences.

Firstly, the major problem as found is a compromise to the user's health due to the chemical nature of the used contact glue. As known, said contact glues, also known as “solvent-based adhesive”, are highly toxic, besides presenting high explosive grade, due to the liberation of harmful gases after their application and during the final drying time. For this reason, it is also advised to make the cover of any item in open and well-ventilated areas. Despite said recommendation, it not always can be followed, as in the case of application of cover plates on the walls of a closed environment.

On the other hand, and as a consequence of its structural characteristics, said cover plates do not have very large mechanical resistance, and, for that reason, cracks and fractures may occur on those plates, especially during the step of finishing and if the user is not used to work with this kind of material.

### OBJECT OF THE INVENTION

Therefore, an object of the present invention is to supply a laminated cover, particularly a laminated finishing cover with high resistance and which is self-adhesive, able to overcome the inconveniences in the state of the art.

More specifically, an object of the present invention is to supply a finishing laminate with a higher resistance over the laminate and/or agglomerate and/or aggregate from which the present laminate is formed.

Furthermore, an object of the present invention is constituted by a finishing laminated cover which may be applied with no need to use contact glues as currently employed.

Finally, a further object of the present invention is a device able to form a laminated cover of the invention.

Said objects are reached by a laminate of the present invention, comprising a layered material comprising a cover plate, an intermediary layer of gluing material and a protection film, wherein said cover plate is intended to compose the external and apparent face of the laminated cover, while the protection film is intended to be taken off before the application of the laminated cover, so to allow the contact between the receiving surface for the laminated cover and the gluing material layer.

Said objects are also reached thanks to a device to form a self-adhesive laminate of the invention, comprising: a parallelepiped structure with an inlet opening and an outlet opening, located at opposed faces in the structure, linear and horizontal trajectory as defined by means of a plurality of small rolls; a pair of traction rolls, located at a nearby position from said inlet opening and at the start of said trajectory; a pair of application rolls, located in an intermediate position of said trajectory; a pair of pressure rolls located at a nearby position of said outlet opening and at the end of said trajectory; a cutting unit located between the application rolls and the pressure rolls; and a controller which is programmed/controlled by a control panel, commanding the operation of the traction rolls and therefore the displacement speed through said trajectory. A reel is also included, intended to store the gluing material comprising a pair of films, so to feed said gluing material into the interspace as formed between the application rolls; as well as a second reel, intended to receive one of the films as taken off from the gluing material of the reel. Description of Drawings

The object of the present invention will be now disclosed based on a preferable way of embodiment, as an illustration and not a limitation, with the support of the attached figures, wherein:

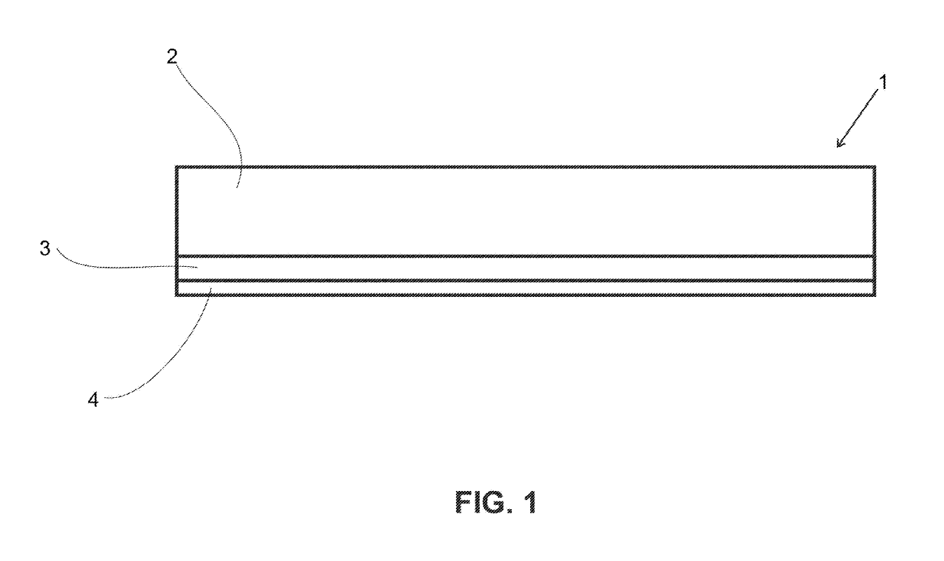

FIG. 1 is a schematic view of the auto-adhesive laminate of the present invention; and

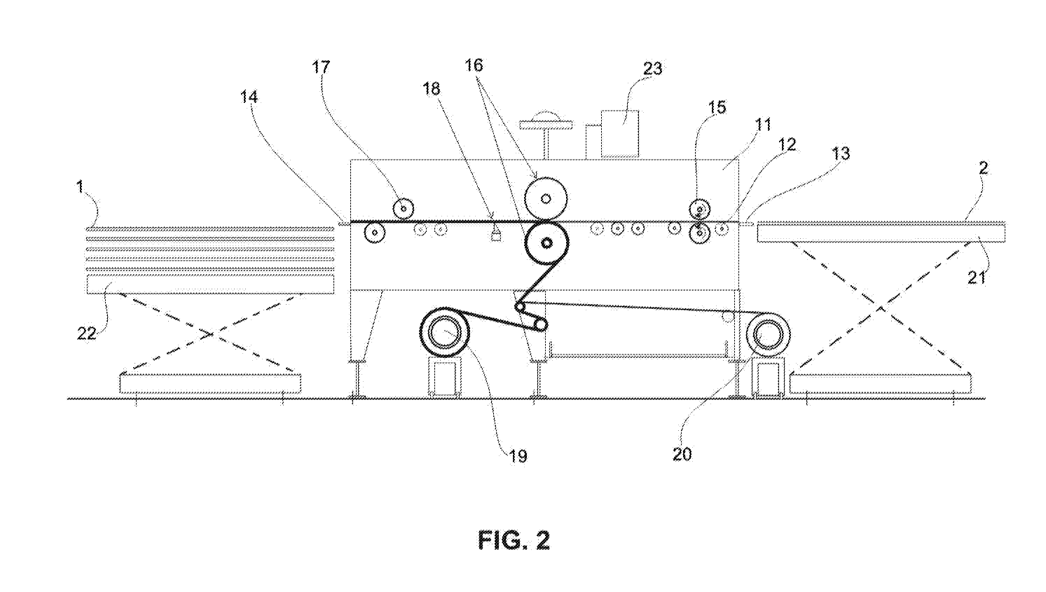

FIG. 2 is a schematic side view of a device of the present invention able to produce the laminate of FIG. 1.

### PREFERRED EMBODIMENT OF THE INVENTION

According to the attached figures, 1 generically discloses a laminate cover which is composed of a covering plate 2 and a gluing material layer 3, located between the lower surface of the cover plate 2 and a protection film 4.

More particularly, the cover plate 2 comprises a conventional product in the market, e. g. an aggregate, agglomerate or laminate, having an external surface and an internal surface, intended to be in contact with the object to be covered, e. g. a piece of furniture, a wall or similar. Said external surface of the cover plate 2 has an ornamental pattern or an embossing, such as noble wood pattern, a colored pattern, be it uniform or not, a stone pattern or any other ornamental pattern as desired. Said cover plate 2 may be preferably an MDF or MDP plate, but it may also be formed by a laminate presenting a conventional aggregate or agglomerate over which a thin layer of a noble wood is fixed, as widely used in the art.

In the case of a cover plate 2 being an MDF or MDP plate, the external surface may present a painted or lacquered finishing, or by the addition of a PVC film or finish foil, according to the skills as known in the art.

The gluing material layer 3 and the corresponding film 4 are obtained from a double-face adhesive, such as widely known in the art. Said double-face adhesive is a particularly interesting material, since it works immediately after taking off said film 4, neither emanating toxic gases nor presenting cautious/dangerous handling. Among double-face adhesives as existing in the market, we can mention, as examples, the following companies/products: Flax' Double Face strip; Phithil; 3M do Brasil; Avery Dennison, Adere, Day Brasil.

The form of application of the adhesive material 3 to form the highly resistant and self-adhesive laminated cover 1 of the invention will be explained below, with comparison to the description of the operation of the device 10.

As a result, the highly resistant and self-adhesive laminated cover 1 of the invention is practical and safe in its use.

Therefore, and to apply the laminated cover 1 over a given surface, we should initially proceed to clean that surface, so to eliminate eventual particles and dirt existing over it, remove the film 4 from the lower surface of the laminated cover 1 and put said laminated cover 1 over the area to be covered. After that, and as usual, we should proceed to a pressure application step, so to guarantee perfect adherence of the laminated cover 1 to said surface or area.

As we can see, the application procedure for the laminated cover 1 is extremely easier and quicker, especially overcoming health and safety problems as inherent to the use of contact glues as currently employed in conventional procedures in the art.

Another inherent advantage of the laminated cover 1 of the invention is an increase in the mechanical resistance of said laminated cover 1 in comparison with the resistance of covers in the state of the art. The incorporation of the gluing material chamber and the corresponding film 4 allows the laminated cover 1 to be transported and installed more safely, i. e. with less risk of breaking or cracking. Furthermore, and after the application of the laminated cover 1 over the surface to be covered, finishing steps (size adjustment and edge trimming) can be performed more safely, even by users who are not used to work with this kind of material.

On the other hand, another object of the present invention is constituted by a device to form a self-adhesive laminated cover 1 as disclosed above.

According to FIG. 2, 10 shows, as a whole, a device to produce the laminated cover 1, basically comprising a parallelepiped structure 11, within which a linear and horizontal trajectory is defined by means of a plurality of small rolls 12. Said trajectory is limited by an inlet opening 13 and an outlet opening 14, located on opposed faces of the structure 11.

Inside said structure 11, following said horizontal trajectory, a pair of traction rolls 15, a pair of application rolls 16 and, finally, a pair of pressure rolls 17 are included. Furthermore, between the application rolls 16 and the pressure rolls 17, a cutting unit 18, e. g. composed by a pneumatically activated knife, is located.

Particularly, traction rolls 15 comprise a pair of rolls which are mechanically activated by a motor (not shown), which operation is controlled by a control center (not shown) which is programmed/controlled by the panel 23. Said rolls 15 are located near the inlet opening 13 and act so to traction and control the displacement speed of each cover plate 2 from inside the device 10.

On the other hand, application rolls 16 comprise a pair of vertically located rolls, and between them an interspace able to allow the passage of the cover plate 2, together with the gluing material 3 and the respective film 4, is defined, by means of application of moderate and pre-determined pressure. Particularly, the lower application roll 16 is partially involved by the gluing material layer 3 and the respective film 4, wherein said film 4 is in contact with the surface of the lower application roll 16, while the gluing material 3 is located outside said lower application roll 16.

Finally, the device 10 also has a pair of pressure rolls 17, located downstream from the cutting unit 18, intended to perform a final compression operation for the gluing material 3 and the respective film 4 on the lower face of the cover plate 2.

The device 10 also comprises a reel 19, located below and outside said device 10, which is intended to store the gluing material 3 as received, i. e. comprising a pair of films, each one located over one of its contact faces, and intended to keep the integrity of the material before use, also avoiding it from gluing over itself when involved in said reel 19. Also outside the device 10, a second reel 20 is included, intended to receive one of the films as taken off from the gluing material of the reel 19, which is activated with a respective engine (not shown).

Finally, a pair of hydraulic tables 21, 22, respectively located next to the inlet 13 and outlet 14 openings, which height can be controlled, is also included, so to facilitate the introduction of the cover plate 2 and the outlet of the laminated cover 1 as produced.

Alternatively, the table 21 may be coupled to an automatic feeder (not shown), intended to introduce, one by one, cover plates 2 into the respective inlet opening 13 of the device 10.

Concerning the operation, the device 10 is very simple and efficient. Therefore, we initially schedule the control center, by means of the panel 23, with the required information for the intended production, i. e. the size of the cover plates 2, the speed of operation (rotation of traction rolls 15) and others. The reel 19 is then put in, over which the gluing material 3 and the respective protection films 4 are rolled, conducting the edge of said material to the application rolls 16.

Particularly, one of the protection films for the gluing material 3 is taken off and guided to the reel 20, so that the gluing material 3 is sent to the application rolls 16 just with a film 4, particularly intended to keep contact with the surface of the lower application roll 16 and therefore the lower face of the laminated cover 1 in production.

Finally, the tables 21 and 22 are respectively positioned next to the inlet 13 and outlet 14 openings of the device 10, wherein, in this situation, the table 21 is loaded with a pile of cover plates 2, while the table 22 is free to receive laminated covers 1 in production.

After the preparation of the device 10 is finished, it may be operated by the panel 23. With the operation, one by one, cover plates 2 are introduced in the opening 13, manually or automatically, being then transported over the rolls 12 and according to the speed as determined by the traction rolls 15. When the interspace between the application rolls 16 is reached, the gluing material 3 adheres to the lower surface of the cover plate 2, fixing itself to it.

More specifically, before the first cover plate 2 arrives at the region of the interspace between the application rolls 16, said application rolls 16 are fixed and have the gluing material 3 located around the lower application roll 16. The adhering surface of the gluing material 3 is located outside the lower application roll 16, as already explained, i. e. defining the lower portion of the interspace between the application rolls 16. Therefore, and since the size of the interspace is lower than the height of the cover place 2 plus the thickness of the gluing material 3 (so to effect the application/adhesion of the gluing material 3 by moderate pressure), when the cover plate 2 arrives at said interspace, it will start tractioning the gluing material 3, together with the film 4, at the same time of the adhesion of the gluing material 3 to the lower surface of the cover plate 2.

While this first cover place 2 goes through the application rolls 16, it loses contact with the traction rolls 15, thus starting to be pushed by the following cover plate 2. In other words, each new cover plate 2 fed at the opening 13, by the action of the traction rolls 15, is not only displaced through said trajectory, but also pushes cover plates 2 located inside the device 10.

After the first cover place 2 has received the gluing material 3 jointly with the film 4, it continues going through the trajectory until its rear edge is aligned to the cutting unit 18. In that position, the knife of the cutting unit 18 is activated, puncturing the layer of gluing material 3 and the respective film 4, but not reaching the cover plate 2.

Finally, the set formed by the cover plate 2, the layer of gluing material 3 and the respective film 4 is later submitted to final compression by the pressure rolls 17. Said step is important to guarantee perfect adherence between the cover plate 2 and the gluing material 3, so defining the laminated cover 1 of the invention.

When leaving the device 10, each laminated cover 1 as produced is settled in the form of a pile, over the table 22 which, from time to time, can be taken off and substituted with a new and empty table 22.

As a result, we can notice that the device 10, as imagined, is able to make a very efficient and agile production in series of the laminated covers 1 of the invention. According to the tests as effected, the production capacity of one such device is about 4 meters of laminated cover per minute. Considering a standard size of 3.08 meters for each laminated cover, the production of about 1.3 laminates per minute results, not taking into account particular adjustments which may increment even more said production capacity.

1. Highly resistant self-adhesive laminated cover, characterized by comprising a layered material comprising a cover plate, an intermediary layer of gluing material and a protection film, wherein said cover plate is intended to compose the external and apparent face of the laminated cover, while the protection film is intended to be taken off before the application of the laminated cover, so to allow the contact between the receiving surface for the laminated cover and the gluing material layer.

2. The laminated cover of claim 1, characterized by said external surface of the cover plate having an ornamental pattern or an embossing.

3. The laminated cover of claim 1, characterized by the cover plate being an agglomerated MDF or MDP plate.

4. The laminated cover of claim 1, characterized by said layer of gluing material and the respective film being obtained from a double-face adhesive.

5. A device to form a self-adhesive laminated cover, characterized by comprising:
a parallelepiped structure having an inlet opening and an outlet opening, provided on opposed faces in the structure;
a linear and horizontal trajectory defined by means of a plurality of small rolls;
a pair of traction rolls, located in a nearby position for said inlet opening and at the start of said trajectory;
a pair of application rolls, located in an intermediate position for said trajectory;
a pair of pressure rolls, located in a nearby position for said inlet opening and at the start of said trajectory;
a cutting unit located between the application rolls and the pressure rolls; and
a controller which is programmable/controlled by a control panel, which controls the activation of the traction rolls and thus the displacement speed through said trajectory.

6. The device of claim 5, characterized by further comprising:
a reel intended to store the gluing material comprising a pair of films, so to feed said gluing material into the interspace as formed between the application rolls; and
a reel intended to receive one of the films as taken off from the gluing material of the reel.

7. The device of claim 5, characterized by further comprising a pair of hydraulic tables respectively located next to the inlet and outlet openings, which height is controllable.

8. The device of claim 7, characterized by said table being coupled to an automatic feeder, intended to introduce, one by one, cover plates into the respective inlet opening of said device.

9. A highly resistant self-adhesive laminated cover, characterized by being produced from a device of claim 5.

10. A highly resistant self-adhesive laminated cover, characterized by being produced from a device of claim 6.

11. A highly resistant self-adhesive laminated cover, characterized by being produced from a device of claim 7.

12. A highly resistant self-adhesive laminated cover, characterized by being produced from a device of claim 8.

13. The laminated cover of claim 1, wherein the pattern is a noble wood pattern, a colored pattern, or a stone pattern.
